(19) United States
(12) Patent Application Publication
(10) Pub. No.: US 2026/0093249 A1
(43) Pub. Date: Apr. 2, 2026

(54) FUNCTIONALLY SAFE PROCESSOR SYSTEM

(71) Applicant: QUALCOMM Incorporated, San Diego, CA (US)

(72) Inventors: Vijay Kiran KALYANAM, Bangalore (IN); Vicente Enrique CHUNG, Austin, TX (US); Amit ANEJA, Chandler, AZ (US); Stephen SHANNON, Austin, TX (US); Suresh Kumar VENKUMAHANTI, Austin, TX (US)

(21) Appl. No.: 19/255,927

(22) Filed: Jun. 30, 2025

Related U.S. Application Data
(63) Continuation of application No. 18/900,025, filed on Sep. 27, 2024.

(51) Int. Cl. G05B 23/02

(52) U.S. Cl. CPC G05B 23/0235

(57) ABSTRACT

Aspects of the disclosure are directed to functional safety (FUSA) via performance monitoring and logic, memory error detection and protection monitoring. In accordance with one aspect, the disclosure includes incrementing each of a plurality of functional safety (FUSA) monitoring counters upon detection of a functional safety (FUSA) event, wherein the plurality of FUSA monitoring counters is part of a hardware-based monitoring system; comparing the plurality of FUSA monitoring counters to a plurality of functional safety (FUSA) counter thresholds using a push methodology; generating at least one interrupt signal and sending the at least one interrupt signal to a FUSA control module if at least one of the plurality of FUSA monitoring counters exceeds at least one of the plurality of FUSA counter thresholds; and executing a state transition to a functional safety (FUSA) safe state using the push methodology based on the at least one interrupt signal.

### CLAIM OF PRIORITY

This application is a continuation application of patent application Ser. No. 18/900,025 filed Sep. 27, 2024, the entire contents of the prior application are incorporated herein by reference as if fully set forth below in its entirety and for all applicable purposes.

### TECHNICAL FIELD

This disclosure relates generally to the field of electronics systems, and, in particular, to functional safety via performance monitoring and logic, memory error detection and protection monitoring.

### BACKGROUND

An electronics system, such as an automotive electronics system, may be subject to stringent safety requirements. For example, automobile use cases such as advanced driver assistance system (ADAS) and advanced driving system (ADS) may include certain capabilities such as vehicle lane centering, pedestrian detection, highway autopilot, etc. These capabilities operate in real time and may require mission critical fail-safe systems. Error detection and error protection require continuous monitoring to avoid a fail-safe fault. For example, detection of parity or memory protection status and illegal state transitions are desired implementations. An absence of functional safety (FUSA) monitoring and action may pose a risk in automobile applications.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides functional safety via performance monitoring and logic, memory error detection and protection monitoring. Accordingly, the present disclosure discloses an apparatus including: a plurality of hardware registers wherein at least one of the plurality of hardware registers is configured to compare at least one of a plurality of functional safety (FUSA) monitoring counters to at least one of a plurality of functional safety (FUSA) counter thresholds using a push methodology, wherein the plurality of FUSA monitoring counters includes a functional safety (FUSA) error counter, a functional safety (FUSA) warning counter and a reference time window for clearing; and a plurality of hardware logical circuits coupled to the plurality of hardware registers, wherein at least one of the plurality of hardware logical circuits is configured to generate at least one interrupt signal and is further configured to send the at least one interrupt signal to a functional safety (FUSA) control module if at least one of the plurality of FUSA monitoring counters exceeds at least one of the plurality of FUSA counter thresholds. In one example, the reference time window is implemented with a timer and a programmable timer threshold for reference time management.

In one example, the apparatus further includes a controller coupled to one or more of the plurality of hardware registers, the controller configured to execute a state transition to a functional safety (FUSA) safe state using the push methodology based on the at least one interrupt signal. In one example, the at least one of the plurality of hardware registers is further configured to increment each of the plurality of FUSA monitoring counters upon detection of a functional safety (FUSA) event. In one example, the apparatus further includes a hardware-based monitoring system configured to house the plurality of FUSA monitoring counters.

In one example, the apparatus further includes a performance monitoring unit (PMU) and logic, memory error detection and protection monitoring coupled to one or more of the plurality of hardware registers configured to update in the FUSA safe state. In one example, the at least one of the plurality of hardware registers is further configured to reset the plurality of FUSA monitoring counters to an updated state and is further configured to initialize the plurality of FUSA monitoring counters to zero.

Another aspect of the disclosure provides a method including: incrementing each of a plurality of functional safety (FUSA) monitoring counters upon detection of a functional safety (FUSA) event, wherein the plurality of FUSA monitoring counters includes a functional safety (FUSA) error counter, a functional safety (FUSA) warning counter and a reference time window for clearing, and wherein the plurality of FUSA monitoring counters is part of a hardware-based monitoring system; comparing the plurality of FUSA monitoring counters to a plurality of functional safety (FUSA) counter thresholds using a push methodology; generating at least one interrupt signal and sending the at least one interrupt signal to a FUSA control module if at least one of the plurality of FUSA monitoring counters exceeds at least one of the plurality of FUSA counter thresholds; and executing a state transition to a functional safety (FUSA) safe state using the push methodology based on the at least one interrupt signal.

In one example, the method further includes implementing the reference time window with a timer and a programmable timer threshold for reference time management. In one example, the method further includes clearing one or more of the plurality of FUSA monitoring counters and clearing the timer when the timer reaches the programmable timer threshold and there is no error state.

In one example, the plurality of FUSA monitoring counters includes a functional safety (FUSA) error counter and a functional safety (FUSA) warning counter. In one example, the method further includes incrementing the FUSA error counter for every occurrence of a functional safety (FUSA) error event. In one example, the method further includes incrementing the FUSA warning counter for every occurrence of a functional safety (FUSA) warning event. In one example, the push methodology is a proactive functional safety (FUSA) monitoring capability without a triggering event.

In one example, the method further includes updating a processor in the FUSA safe state. In one example, the method further includes resetting the plurality of FUSA monitoring counters to an updated state. In one example, the method further includes initializing the plurality of FUSA monitoring counters to zero. In one example, the FUSA control module is part of an external safety entity. In one example, the external safety entity is a higher-level safety entity.

Another aspect of the disclosure provides an apparatus including: means for incrementing each of a plurality of functional safety (FUSA) monitoring counters upon detection of a functional safety (FUSA) event, wherein the plurality of FUSA monitoring counters includes a functional safety (FUSA) error counter, a functional safety (FUSA) warning counter and a reference time window for clearing, and wherein the plurality of FUSA monitoring counters is part of a hardware-based monitoring system; means for implementing the reference time window with a timer and a programmable timer threshold for reference time management; means for comparing the plurality of FUSA monitoring counters to a plurality of functional safety (FUSA) counter thresholds using a push methodology; means for generating at least one interrupt signal and sending the at least one interrupt signal to a FUSA control module if at least one of the plurality of FUSA monitoring counters exceeds at least one of the plurality of FUSA counter thresholds; and means for executing a state transition to a functional safety (FUSA) safe state using the push methodology based on the at least one interrupt signal.

In one example, the plurality of FUSA monitoring counters includes a functional safety (FUSA) error counter and a functional safety (FUSA) warning counter. In one example, the apparatus further includes: means for updating a processor in the FUSA safe state; means for comparing the FUSA error counter to a FUSA error threshold; and means for comparing the FUSA warning counter to a FUSA warning threshold. In one example, the apparatus further includes: means for resetting the plurality of FUSA monitoring counters to an updated state; and means for initializing the plurality of FUSA monitoring counters to zero. In one example, the timer reaches the programmable timer threshold and there is no error state, one or more of the plurality of FUSA monitoring counters and the timer are cleared.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example functional safety (FUSA) state sequence overview during a failure event.

FIG. 2 illustrates an example fault hierarchy.

FIG. 3 illustrates a first example use case for performance monitoring and logic, memory error detection and protection monitoring without functional safety (FUSA).

FIG. 4 illustrates an example functional safety (FUSA) performance monitoring solution.

FIG. 5 illustrates an example functional safety (FUSA) memory and logic error monitoring solution.

FIG. 6 illustrates an example timeline for functional safety (FUSA) performance monitoring.

FIG. 7 illustrates an example functional safety (FUSA) performance monitoring use case.

FIG. 8 illustrates an example flow diagram for implementing functional safety (FUSA) via performance monitoring and logic, memory error detection and protection monitoring.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

In contemporary automobiles, an automotive electronics system is a pervasive and critical constituent of the automotive operation. For example, the automotive electronics system monitors and controls various automotive subsystems, such as the engine, powertrain, transmission, braking, body, suspension, power steering, battery, etc. In one example, an automobile should comply with functional safety (FUSA) requirements. For example, FUSA refers to safety mechanisms placed in a design to ensure safe operation in case of an unexpected failure (i.e., fail-safe operation).

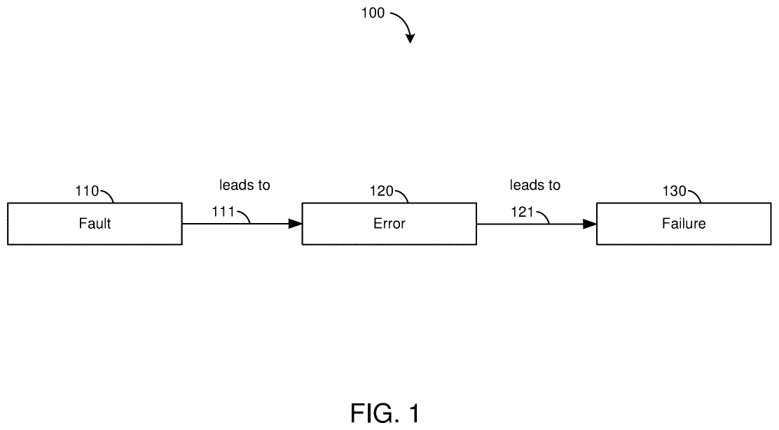

FIG. 1 illustrates an example functional safety (FUSA) state sequence overview 100 during a failure event. In one example, the FUSA state sequence overview 100 commences with a fault state 110. In one example, the fault state 110 transitions to an error state 120 via a first transition path 111. In one example, the error state 120 transitions to a failure state 130 via a second transition path 121.

In one example, a fault is an abnormal condition which may cause an element or an item in a system to fail. The fault may be a permanent fault, an intermittent fault or a transient fault (e.g., a soft error). In one example, functional safety (FUSA) is an absence of unreasonable risk due to hazards caused by malfunctioning behavior of electrical or electronic systems. In one example, an automotive safety integrity level (ASIL) is one of four levels with specific International Organization for Standardization requirements (e.g., ISO 26262 Road vehicles-functional safety requirements) and safety measures to apply for avoiding an unreasonable risk. For example, a fourth ASIL level, ASIL-D, represents a most stringent level and a first ASIL level, ASIL-A, represents a least stringent level.

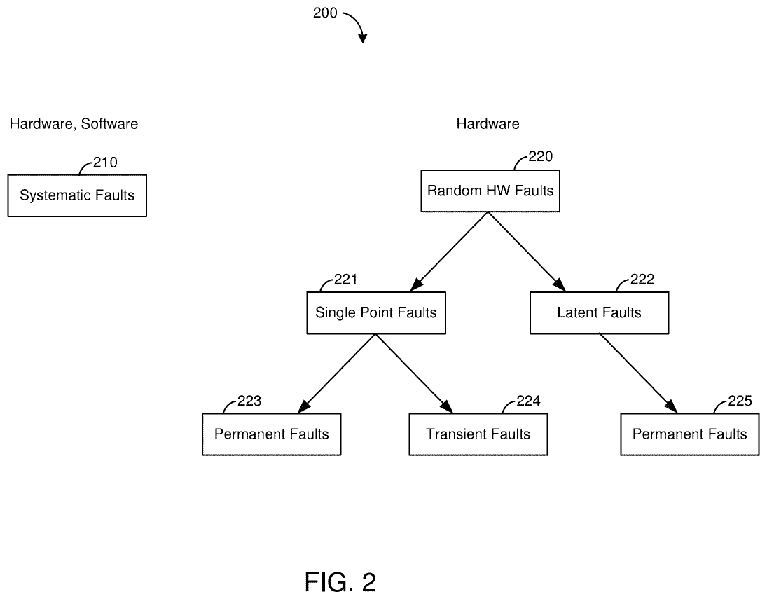

FIG. 2 illustrates an example fault hierarchy 200. In one example, the fault hierarchy 200 includes two major fault categories: systematic faults 210 and random faults 220. For example, systematic faults 210 may be due to hardware, software or both. In one example, random faults 220 may be due to hardware. For example, the random faults 220 may include both single point faults 221 and latent faults 222. The single point faults 221 may include permanent faults 223 and transient faults 224. And, the latent faults 222 may include other permanent faults 225.

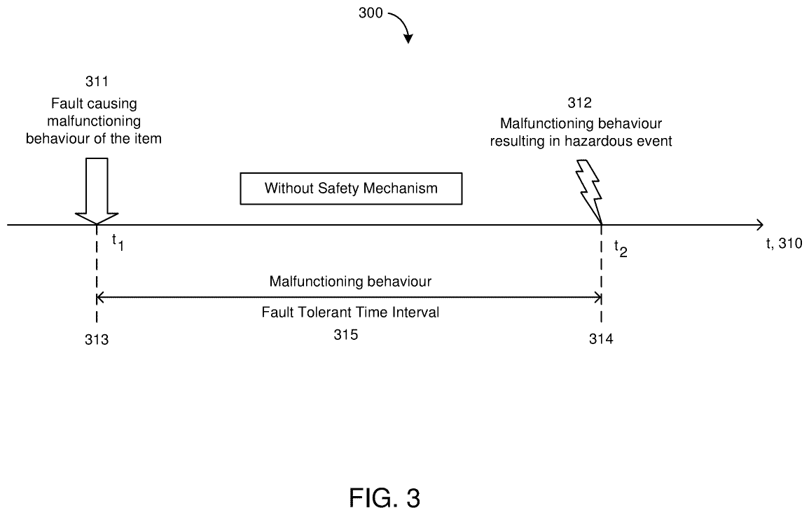

FIG. 3 illustrates a first example use case 300 for performance monitoring and logic, memory error detection and protection monitoring without functional safety (FUSA). In one example, a timeline 310 shows a sequence of events relating to performance monitoring or error detection and protection monitoring. In one example, a fault occurrence 311 occurs at a first time epoch t₁ 313. The fault occurrence may cause malfunctioning in an automotive electronics system. Subsequently, the fault occurrence 311 leads to a malfunctioning behavior 312 at a second time epoch t₂ 314. In one example, the malfunctioning behavior 312 may result in a hazardous event in the automotive electronics system due to a lack of a safety mechanism. In one example, a time duration between the first time epoch t₁ 313 and the second time epoch t₂ 314 is a fault tolerant time interval 315.

A fault, for example, may refer to any performance reduction of automotive use cases beyond a real-time or mission critical time limit which leads to performance faults. In one example, any error detection and protection mechanism may require monitoring to maintain a fail-safe operation.

Maintenance of safe operation in an automotive electronics system may require functional safety (FUSA) monitoring, detection and action. In one example, functional safety (FUSA) by a neural signal processor (NSP) may include performance, logic/memory error detection and protection monitoring. In one example, an automotive electronics system may include a plurality of performance monitoring unit (PMU) event counters (e.g., to provide performance metrics), logic/memory error detection and protection monitoring via a plurality of FUSA counters. In one example, performance faults, parity/memory faults, illegal state transition detections, etc. may be detected through triggering a warning or error interrupt signals upon a violation of FUSA monitoring thresholds or violation of any performance of logic/memory faults. In one example, a resulting FUSA action from an external safety entity may put the automotive electronics system in a safe operational mode which prevents a system failure or promotes a safe failure.

In one example, FUSA monitoring and action includes at least two elements: fault detection and fault mitigation. In one example, fault detection includes FUSA monitoring of a selected performance monitoring unit (PMU). In one example, fault detection includes FUSA monitoring of a memory fault, parity fault or illegal transition event to flag a FUSA threshold violation. Fault detection, for example, may result in a generation of a warning signal and an error interrupt signal.

In one example, fault mitigation includes alerting an external safety entity (e.g., a higher level safety entity such as an automotive user application, external safety processor, etc.) of an unexpected slowdown in system performance. In one example, fault mitigation includes handling of the warning signal and the error interrupt signal by transitioning the automotive electronics system to a safe state.

In one example, the FUSA monitoring and action may be implemented as a hardware solution which has a much shorter response time compared to a software solution. In one example, the hardware solution implements a push methodology for warning and error interrupt signal generation which is continually operational versus a pull or polling methodology used in other solutions. The push methodology is a proactive monitoring and action strategy. The pull methodology is a reactive monitoring and action strategy. In one example, the polling methodology is a scheduled monitoring and action strategy.

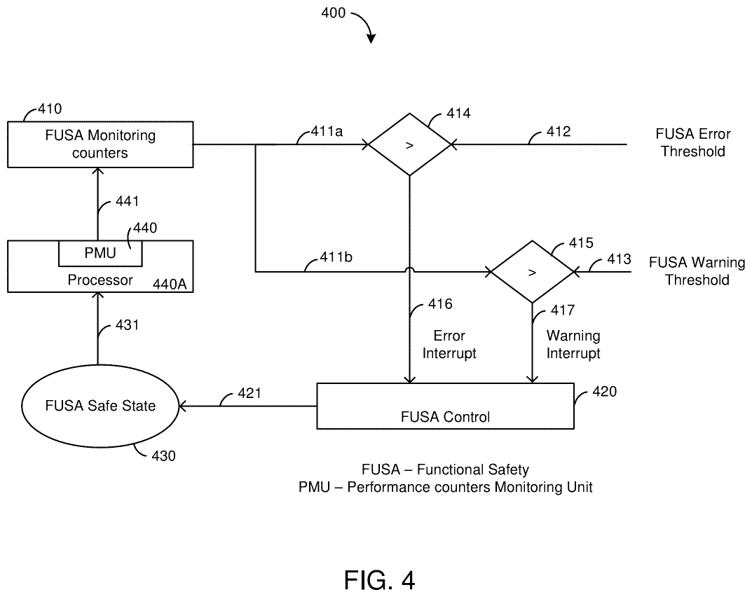

FIG. 4 illustrates an example functional safety (FUSA) performance monitoring solution 400. In one example, a plurality of FUSA monitoring counters 410 provides a FUSA error count 411a and a FUSA warning count 411b. For example, the FUSA error count 411a is compared to the FUSA error count threshold 412 in a first comparison block 414. In one example, if the FUSA error count 411a exceeds the FUSA error threshold 412, then generate an error interrupt signal 416; otherwise, continue monitoring in an operational state. In one example, the FUSA warning count 411b is compared to a FUSA warning count threshold 413 in a second comparison block 415. In one example, if the FUSA warning count 411b exceeds the FUSA warning count threshold 413, then generate a warning interrupt signal 417; otherwise, continue monitoring in an operational state. In one example, the FUSA error count 411a is compared to the FUSA error count threshold 412 in a first comparison block 414. In one example, a higher level entity or external processor may choose to aggregate or monitor frequency, density of warning interrupts to take action to transition to FUSA safe state.

In one example, the error interrupt signal 416 and the warning interrupt signal 417 are sent to a FUSA control block 420 for fault mitigation. In one example, the FUSA control block 420 is an external safety entity. In one example, the FUSA control block 420 sends a state transition signal 421 to trigger a FUSA safe state 430. In one example, the FUSA safe state 430 may perform an action to alter automotive operation for safety (e.g., slow down the car or a driver may get alerted to regain control over the advanced driver assistance system and advanced driving system (ADAS/ADS), etc.).

In one example, a processor 440A is transitioned to the FUSA safe state 430 by a safe state transition signal 431 triggered by the FUSA control block 420. In one example, a PMU 440 sends a performance monitoring unit (PMU) output signal 441 to the plurality of FUSA monitoring counters 410. In one example, the plurality of FUSA monitoring counters 410 includes PMU counters and logic, memory error detection and protection monitoring. In one example, the plurality of FUSA monitoring counters 410 use a threshold of zero and any reported error is treated as high severity with immediate reporting to a higher safety entity. For example, each counter of the plurality of FUSA monitoring counters 410 may be a 1 bit counter with a zero threshold.

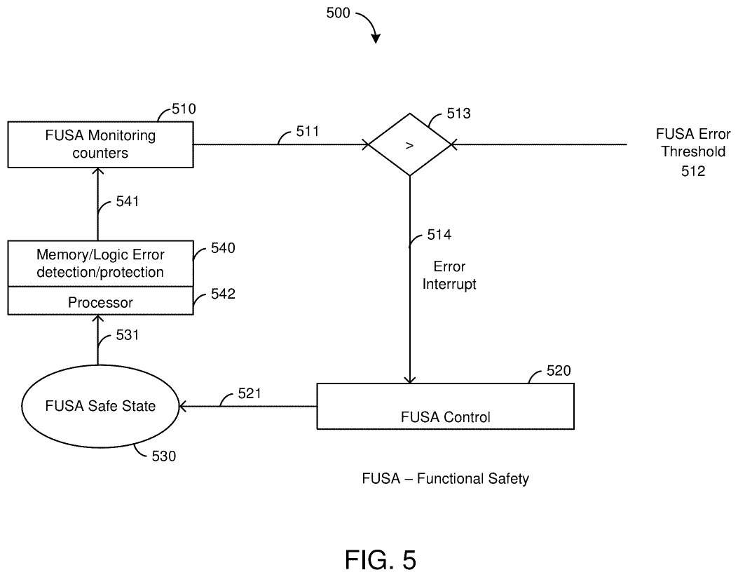

FIG. 5 illustrates an example functional safety (FUSA) memory and logic error monitoring solution 500. In one example, a plurality of FUSA monitoring counters 510 provides a FUSA error count 511. In one example, the FUSA error count 511 is compared to FUSA error count threshold 512 in a comparison block 513. In one example, if the FUSA error count 511 exceeds the FUSA error threshold 512, then generate an error interrupt signal 514; otherwise, continue monitoring in an operational state and reset/update counters at the end of a time interval window.

In one example, the error interrupt signal 514 is sent to a FUSA control block 520 for fault mitigation. In one example, the FUSA control block 520 is an external safety entity. In one example, the FUSA control block 520 sends a state transition signal 521 to trigger a FUSA safe state 530. In one example, the FUSA safe state 530 may perform processor shut down or may stop the processor operation for safety (e.g., park the car etc.).

In one example, the FUSA safe state 530 sends a safe state signal 531 to a memory/logic error detection and protection unit 540, hosted on a processor 542. In one example, the memory/logic error detection and protection unit 540 sends a detection output signal 541 to the plurality of FUSA monitoring counters 510.

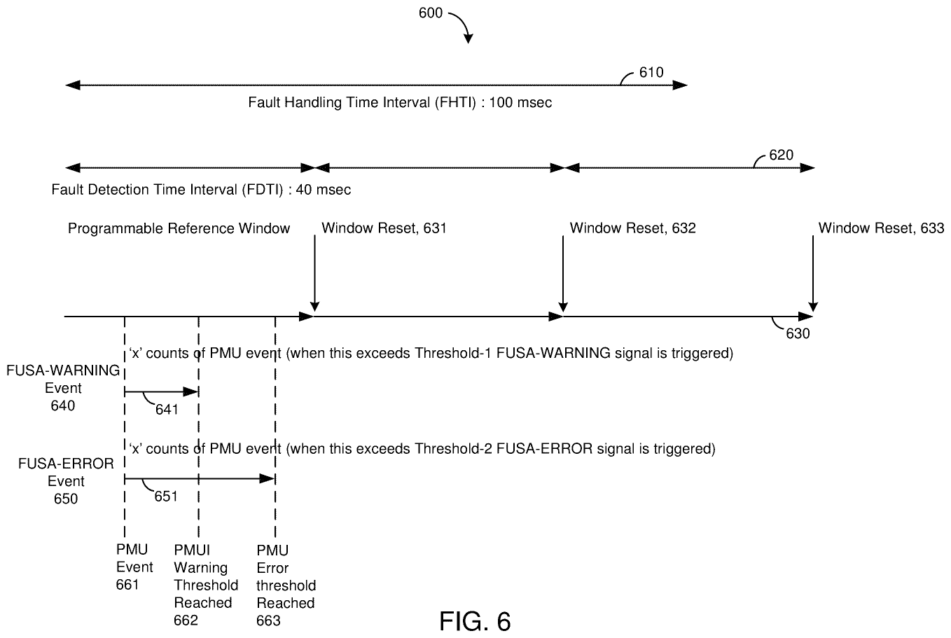

FIG. 6 illustrates an example timeline 600 for functional safety (FUSA) performance monitoring. As illustrated, the example timeline illustrates a framework for detection of an unexpected performance impact applicable for any performance monitoring unit (PMU) event monitored for FUSA. In one example, a fault handling time interval (FHTI) 610 has a time duration of 100 ms. In one example, a programmable reference window 620 includes a plurality of fault detection time intervals (FDTI). And, in the example illustrated, each FDTI has a time duration of 40 ms. In one example, a time window 630 includes a plurality of time window reset marks with a first time window reset mark 631, a second time window reset mark 632, a third time window reset mark 633, etc. One skilled in the art would understand that the quantity of time window reset marks shown herein is an example, and that other quantities are also within the spirit and scope of the present disclosure. In one example, each window time reset mark resets a FUSA monitoring counter and may reset a time window timer.

In one example, a FUSA warning event sequence 640 includes a first count of PMU events 641 after a triggering by a PMU event 661, In one example, a FUSA warning signal is generated when the first count of PMU events 641 exceeds a PMU warning threshold 662.

In one example, a FUSA error event sequence 650 includes a second count of PMU events 651 after the triggering by the PMU event 661. In one example, a FUSA error signal is generated when the second count of PMU events 651 exceeds a PMU error threshold 663.

In one example, for advanced driver assistance system (ADAS) applications (e.g., collision avoidance) a set of safety functions may execute repeatedly in a fixed sequence. For example, a camera-based perception algorithm running on a neural signal processor (NSP) may perform obstacle detection (e.g., detecting a pedestrian, cyclist, vehicle, etc.). In one example, the advanced driver assistance system (ADAS) application may execute with a fault handling time interval (FHTI) of approximately 100 ms, and a SoC may be allocated approximately 40 ms for proactive fault detection (i.e., fault detection time intervals (FDTI) is approximately 40 ms). In one example, certain processor event activations as measured by the PMU counters, which are too frequent or with a long time duration, may lead to a performance fault. In one example, a fault detection may trigger a system level action, for example, a driver may get alerted to regain control over the advanced driver assistance system and advanced driving system (ADAS/ADS).

In one example, a hardware implementation may include the PMU counter with a reference time window and a recurring hardware sequence. In one example, an excessive quantity of certain processor event activations as measured by the PMU counters which cause performance degradation may be detected and result in a FUSA warning signal or a FUSA error signal. In one example, the reference time window may be implemented with a timer and a programmable timer threshold for reference time window measurement. In one example, the FUSA error event sequence 650 is compared against a warning threshold and an error threshold to generate the FUSA warning signal and the FUSA error signal. In one example, when the timer reaches the timer threshold, the PMU counter and the timer are cleared if not in an error state. For example, if the timer threshold is 100 ms, the reference time window restarts and the PMU counter and the timer are cleared after a 100 ms period. In one example, the FUSA warning signal or FUSA error signal may be sent to an external safety entity to transition the automotive electronics system to a safe state. In one example, the PMU counter is one of the FUSA monitoring counters. In one example, the PMU counter is a FUSA error counter or a FUSA warning counter.

In one example, definition of PMU events may be configurable as events of interest with specific thresholds. For example, PMU events may be defined for various functional safety relevant events.

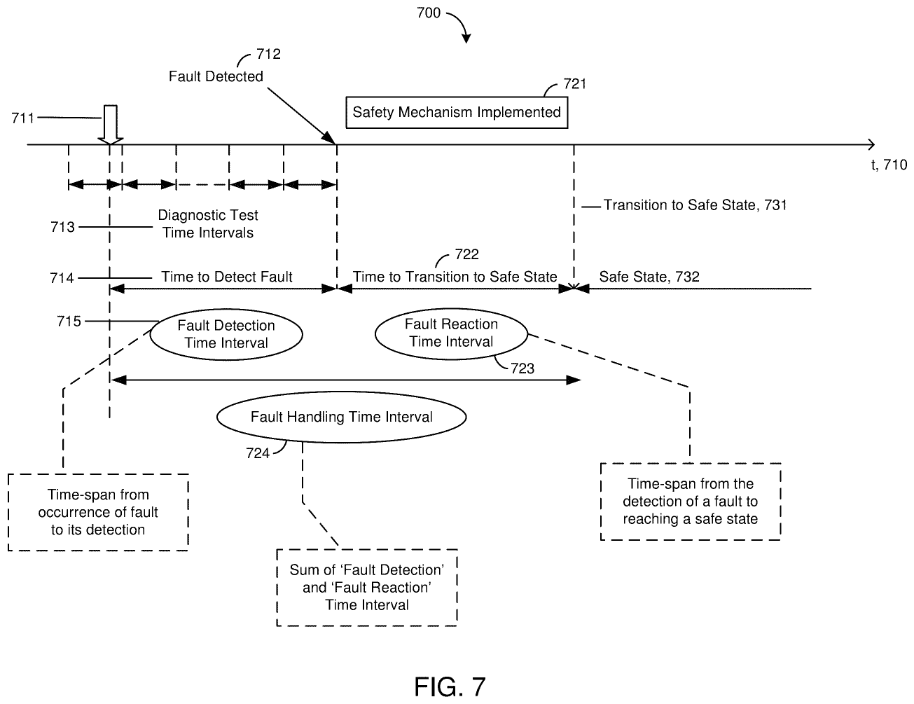

FIG. 7 illustrates an example functional safety (FUSA) performance monitoring use case 700. In one example, on a reference timeline 710, a fault occurs at a fault occurrence time 711 and the fault is detected at a fault detection time 712. In one example, a plurality of diagnostic time intervals 713 prior to the fault detection time 712. In one example, a time duration to detect fault 714 (i.e., a fault detection time interval 715) is a difference between the fault detection time 712 and the fault occurrence time 711.

In one example, a safety mechanism is implemented 721 subsequent to the fault detection time 712. In one example, a state transition time 731 marks a transition to a safe state 732. In one example, a time duration to transition to safe state 722 (i.e., a fault reaction time interval 723) is a difference between the state transition time 731 and the fault detection time 712. In one example, a fault handling time interval 724 is a sum of the fault detection time interval 715 and the fault reaction time interval 723.

In one example, a fault refers to any performance reduction in automotive electronics system use cases beyond real time or mission critical time limits which may lead to performance faults.

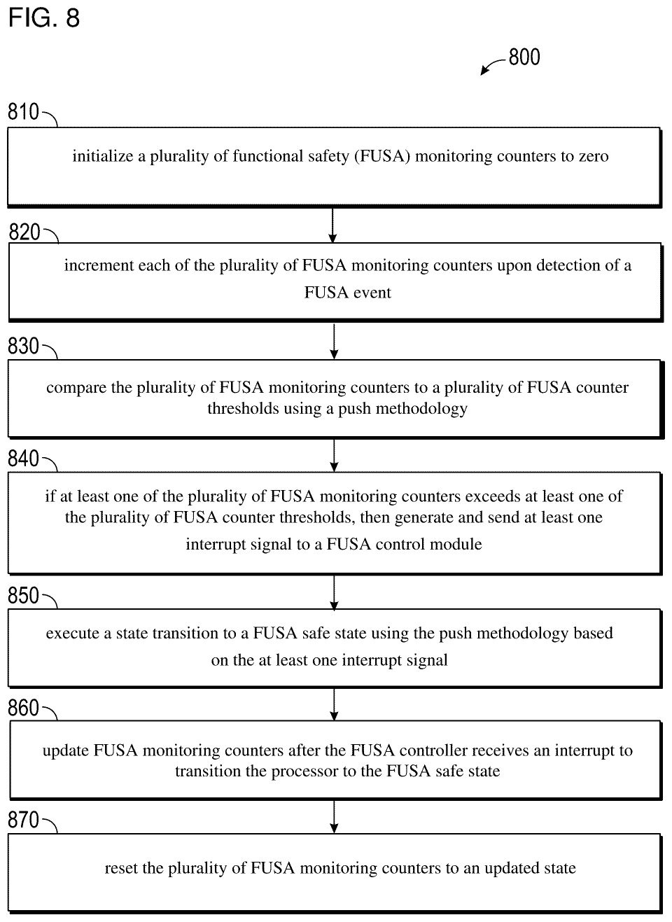

FIG. 8 illustrates an example flow diagram 800 for implementing functional safety (FUSA) via performance monitoring and logic, memory error detection and protection monitoring. In block 810, initialize a plurality of functional safety (FUSA) monitoring counters to zero. In one example, a plurality of functional safety (FUSA) monitoring counters is initialized to zero. In one example, the plurality of FUSA monitoring counters includes a FUSA error counter and a FUSA warning counter. In one example, the plurality of FUSA monitoring counters is part of a hardware-based monitoring system. In one example, the hardware-based monitoring system is part of an automotive electronics system. In one example, the step of block 810 is performed by hardware registers, for example, in a processing engine. In another example, the step of block 810 is performed by an application specific integrated circuit (ASIC) or a field programmable gate array (FPGA).

In block 820, increment each of the plurality of FUSA monitoring counters upon detection of a FUSA event. In one example, each of the plurality of FUSA monitoring counters is incremented upon detection of a FUSA event. In one example, the FUSA error counter is incremented for every occurrence of a FUSA error event. In one example, the FUSA warning counter is incremented for every occurrence of a FUSA warning event. In one example, the FUSA error event includes a performance monitoring unit (PMU) event, a logic or memory error detection event, a protection monitoring event, etc. In one example, the FUSA warning event includes a performance fault event, parity/memory fault event, an illegal state transition event, etc. In one example, the step of block 820 is performed by hardware registers, for example, in a processing engine. In another example, the step of block 820 is performed by an application specific integrated circuit (ASIC) or a field programmable gate array (FPGA).

In block 830, compare the plurality of FUSA monitoring counters to a plurality of FUSA counter thresholds using a push methodology. In one example, the plurality of FUSA monitoring counters is compared to a plurality of FUSA counter thresholds using a push methodology. In one example, the FUSA error counter is compared to a FUSA error threshold. In one example, the FUSA warning counter is compared to a FUSA warning threshold. In one example, the push methodology is a proactive FUSA monitoring capability without a triggering event. In one example, the step of block 830 is performed by hardware logical circuits, for example, in a processing engine. In another example, the step of block 830 is performed by an application specific integrated circuit (ASIC) or a field programmable gate array (FPGA).

In block 840, if at least one of the plurality of FUSA monitoring counters exceeds at least one of the plurality of FUSA counter thresholds, then generate and send at least one interrupt signal to a FUSA control module. In one example, if at least one of the plurality of FUSA monitoring counters exceeds at least one of the plurality of FUSA counter thresholds, then at least one interrupt signal is generated and sent to a FUSA control module. In one example, the at least one counter is the FUSA error counter or the FUSA warning counter. In one example, the at least one FUSA counter threshold is the FUSA error threshold or the FUSA warning threshold. In one example, the FUSA control module is part of an external safety entity. In one example, the external safety entity is a higher-level safety entity (e.g., a higher ASIL level entity, a more stringent level entity). In one example, the interrupt signal is an error interrupt signal. In one example, the interrupt signal is a warning interrupt signal. In one example, the step of block 840 is performed by hardware logical circuits, for example, in a processing engine. In another example, the step of block 840 is performed by an application specific integrated circuit (ASIC) or a field programmable gate array (FPGA).

In block 850, execute a state transition to a FUSA safe state using the push methodology based on the at least one interrupt signal. In one example, a state transition is executed to a FUSA safe state using the push methodology based on the at least one interrupt signal. In one example, the state transition execution is initiated by a state transition signal from the FUSA control module. In one example, the FUSA safe state prevents an automotive system failure. In one example, the FUSA safe state results in a fail-safe state. In one example, the step of block 850 is performed by a controller or a microprocessor, for example, in a system on a chip (SoC). In another example, the step of block 850 is performed by an application specific integrated circuit (ASIC) or a field programmable gate array (FPGA).

In block 860, update FUSA monitoring counters (to reset or stop counting) after the FUSA controller receives an interrupt to transition the processor to the FUSA safe state. In one example, the processor is the processor 440A of FIG. 4. In another example, the step of block 860 is performed by an application specific integrated circuit (ASIC) or a field programmable gate array (FPGA).

In block 870, reset the plurality of FUSA monitoring counters to an updated state (e.g., clear/reset or stop incrementing/counting). In one example, the plurality of FUSA monitoring counters is reset to an updated state. In one example, the step of block 870 is performed by hardware registers, for example, in a processing engine. In another example, the step of block 870 is performed by an application specific integrated circuit (ASIC) or a field programmable gate array (FPGA).

In one aspect, one or more of the steps for providing functional safety performance monitoring in FIG. 8 may be executed by one or more processors which may include hardware, software, firmware, etc. The one or more processors, for example, may be used to execute software or firmware needed to perform the steps in the flow diagram of FIG. 8. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a plurality of hardware registers wherein at least one of the plurality of hardware registers is configured to compare at least one of a plurality of functional safety (FUSA) monitoring counters to at least one of a plurality of functional safety (FUSA) counter thresholds using a push methodology, wherein the plurality of FUSA monitoring counters includes a functional safety (FUSA) error counter, a functional safety (FUSA) warning counter and a reference time window for clearing; and
a plurality of hardware logical circuits coupled to the plurality of hardware registers, wherein at least one of the plurality of hardware logical circuits is configured to generate at least one interrupt signal and is further configured to send the at least one interrupt signal to a functional safety (FUSA) control module if at least one of the plurality of FUSA monitoring counters exceeds at least one of the plurality of FUSA counter thresholds.

2. The apparatus of claim 1, wherein the reference time window is implemented with a timer and a programmable timer threshold for reference time management.

3. The apparatus of claim 2, further comprising a controller coupled to one or more of the plurality of hardware registers, the controller configured to execute a state transition to a functional safety (FUSA) safe state using the push methodology based on the at least one interrupt signal.

4. The apparatus of claim 3, wherein the at least one of the plurality of hardware registers is further configured to increment each of the plurality of FUSA monitoring counters upon detection of a functional safety (FUSA) event.

5. The apparatus of claim 4, further comprising a hardware-based monitoring system configured to house the plurality of FUSA monitoring counters.

6. The apparatus of claim 4, further comprising a performance monitoring unit (PMU) and logic, memory error detection and protection monitoring coupled to one or more of the plurality of hardware registers, configured to update in the FUSA safe state.

7. A method comprising:
incrementing each of a plurality of functional safety (FUSA) monitoring counters upon detection of a functional safety (FUSA) event, wherein the plurality of FUSA monitoring counters includes a functional safety (FUSA) error counter, a functional safety (FUSA) warning counter and a reference time window for clearing, and wherein the plurality of FUSA monitoring counters is part of a hardware-based monitoring system;
comparing the plurality of FUSA monitoring counters to a plurality of functional safety (FUSA) counter thresholds using a push methodology;
generating at least one interrupt signal and sending the at least one interrupt signal to a FUSA control module if at least one of the plurality of FUSA monitoring counters exceeds at least one of the plurality of FUSA counter thresholds; and
executing a state transition to a functional safety (FUSA) safe state using the push methodology based on the at least one interrupt signal.

8. The method of claim 7, further comprising implementing the reference time window with a timer and a programmable timer threshold for reference time management.

9. The method of claim 8, further comprising clearing one or more of the plurality of FUSA monitoring counters and clearing the timer when the timer reaches the programmable timer threshold and there is no error state.

10. The method of claim 8 further comprising incrementing the FUSA error counter for every occurrence of a functional safety (FUSA) error event.

11. The method of claim 8 further comprising incrementing the FUSA warning counter for every occurrence of a functional safety (FUSA) warning event.

12. The method of claim 7, wherein the push methodology is a proactive functional safety (FUSA) monitoring capability without a triggering event.

13. The method of claim 7, further comprising updating a processor in the FUSA safe state.

14. The method of claim 13, further comprising resetting the plurality of FUSA monitoring counters to an updated state.

15. The method of claim 14, wherein the FUSA control module is part of an external safety entity.

16. The method of claim 15, wherein the external safety entity is a higher-level safety entity.

17. An apparatus comprising:
means for incrementing each of a plurality of functional safety (FUSA) monitoring counters upon detection of a functional safety (FUSA) event, wherein the plurality of FUSA monitoring counters includes a functional safety (FUSA) error counter, a functional safety (FUSA) warning counter and a reference time window for clearing, and wherein the plurality of FUSA monitoring counters is part of a hardware-based monitoring system;
means for implementing the reference time window with a timer and a programmable timer threshold for reference time management;
means for comparing the plurality of FUSA monitoring counters to a plurality of functional safety (FUSA) counter thresholds using a push methodology;
means for generating at least one interrupt signal and sending the at least one interrupt signal to a FUSA control module if at least one of the plurality of FUSA monitoring counters exceeds at least one of the plurality of FUSA counter thresholds; and
means for executing a state transition to a functional safety (FUSA) safe state using the push methodology based on the at least one interrupt signal.

18. The apparatus of claim 17, further comprising:
means for updating a processor in the FUSA safe state;
means for comparing the FUSA error counter to a FUSA error threshold; and
means for comparing the FUSA warning counter to a FUSA warning threshold.

19. The apparatus of claim 18, further comprising:
means for resetting the plurality of FUSA monitoring counters to an updated state; and
means for initializing the plurality of FUSA monitoring counters to zero.

20. The apparatus of claim 19, wherein when the timer reaches the programmable timer threshold and there is no error state, one or more of the plurality of FUSA monitoring counters and the timer are cleared.
